(19) United States
(12) Patent Application Publication
(10) Pub. No.: US 2002/0080158 A1
(43) Pub. Date: Jun. 27, 2002

(54) Offline data collection

(76) Inventors: Paul D. Storfer, Bedford Hills, NY (US); David Hetzer, Larchmont, NY (US)

Correspondence Address: SWIDLER BERLIN SHEREFF FRIEDMAN, LLP, 3000 K STREET, NW, BOX IP, WASHINGTON, DC, 20007, US

(21) Appl. No.: 09/996,012

(22) Filed: Nov. 29, 2001

Related U.S. Application Data
(60) Provisional application No. 60/250,232, filed on Nov. 30, 2000.

(51) Int. Cl. G09G 5/00

(52) U.S. Cl. 345/700

(57) ABSTRACT

A method, system, and computer program product for offline data collection using data entry forms that are generated and emailed to data entry systems, on which data may then be entered into the data entry forms while the data entry system is not communicatively connected. A data collection process, comprises the steps of building a data entry form for entering requested data, generating an email message including the data entry form, transmitting the email message, receiving an email message including the requested data, and posting the received requested data to a database.

### CROSS-REFERENCE TO RELATED APPLICATIONS

The benefit under 35 U.S.C. § 119(e) of provisional application No. 60/250,232 filed Nov. 30, 2000, is hereby claimed.

### FIELD OF THE INVENTION

The present invention relates to offline data collection using data entry forms that are generated and emailed to data entry systems, on which data may then be entered into the data entry forms while the data entry system is not communicatively connected.

### BACKGROUND OF THE INVENTION

Online data collection and data processing has significantly improved productivity in a variety of applications. For example, many important business processes have been automated using business application software. These applications require data in order to function. Such data may be collected in an automated fashion from other data processing systems, but much data must still be collected manually from individual users. In an online data collection environment, users are connected, directly or through a network, to a data processing system, which collects and processes the data entered by the users. Such a system requires online connection and interaction with the data processing system, which limits the portability and flexibility of the system. A need arises for a data collection system that does not require online connection and interaction with the data processing system

### SUMMARY OF THE INVENTION

The present invention is a method, system, and computer program product for offline data collection using data entry forms that are generated and emailed to data entry systems, on which data may then be entered into the data entry forms while the data entry system is not communicatively connected.

In one embodiment, a data collection process, according to the present invention, comprises the steps of building a data entry form for entering requested data, generating an email message including the data entry form, transmitting the email message, receiving an email message including the requested data, and posting the received requested data to a database.

The data entry form may provide interactive entry of data into the data entry form. The data entry form may be created using at least one of a standard or proprietary document language, a script language, or a programming language. The data entry form may be created using at least one of hypertext markup language, extensible markup language, Java, or Javascript.

The data entry form may provide interactive entry of data into the data entry form in a data entry system while the data entry system is not communicatively connected. The data entry form may be created using at least one of a standard or proprietary document language, a script language, or a programming language. The data entry form may be created using at least one of hypertext markup language, extensible markup language, Java, or Javascript.

The data collection process may further comprise the steps of creating a dataset defining data that is to be collected and selecting a participant in the data collection process. The step of building a data entry form may comprise the step of building a data entry form for entering requested data defined by the dataset for the participant in the data collection process. The step of selecting a participant in the data collection process may comprise the step of selecting a plurality of participants in the data collection process. The step of building a data entry form may comprise the step of building a data entry form for entering requested data defined by the dataset for each participant in the data collection process. The step of generating an email message including the data entry form may comprise the step of generating an email message including the data entry form for each participant in the data collection process. The step of transmitting the email message may comprise the step of transmitting a data entry form to each participant in the data collection process. The step of receiving an email message including the requested data may comprise the step of receiving an email message including the requested data for each participant in the data collection process.

Each data entry form may provide interactive entry of data into the data entry form. Each data entry form may be created using at least one of a standard or proprietary document language, a script language, or a programming language. Each data entry form may be created using at least one of hypertext markup language, extensible markup language, Java, or Javascript. Each data entry form may provide interactive entry of data into the data entry form in a data entry system while the data entry system is not communicatively connected. Each data entry form may be created using at least one of a standard or proprietary document language, a script language, or a programming language. Each data entry form may be created using at least one of hypertext markup language, extensible markup language, Java, or Javascript.

In one embodiment, a data collection process in a data entry system, according to the present invention, comprises the steps of receiving an email message including a data entry form requesting data, extracting the data entry form from the email message, interactively entering the requested data into the data entry form, and transmitting an email message including the entered data. The data collection process may further comprise the step of displaying the data entry form. The data entry form may be created using at least one of a standard or proprietary document language, a script language, or a programming language. The data entry form may be created using at least one of hypertext markup language, extensible markup language, Java, or Javascript.

The data collection process may further comprise the step of displaying the data entry form using a browser program. The data entry form may be created using at least one of a standard or proprietary document language, a script language, or a programming language. The data entry form may be created using at least one of hypertext markup language, extensible markup language, Java, or Javascript.

The step of interactively entering the requested data into the data entry form may comprise the step of interactively entering the requested data into the data entry form while the data entry system is not communicatively connected. The data collection process may further comprise the step of displaying the data entry form. The data entry form may be created using at least one of a standard or proprietary document language, a script language, or a programming language. The data entry form may be created using at least one of hypertext markup language, extensible markup language, Java, or Javascript. The data collection process may further comprises the step of displaying the data entry form using a browser program. The data entry form may be created using at least one of a standard or proprietary document language, a script language, or a programming language. The data entry form may be created using at least one of hypertext markup language, extensible markup language, Java, or Javascript.

In one embodiment, a process for collaborative creation of descriptions of competencies related to a position defined by a job model, according to the present invention, comprises the steps of creating a person listing including information relating to potential participants and available types of job models, selecting a participant and a job model, building a data entry form for entering requested data based on the selected job model, generating an email message including the data entry form, transmitting the email message, receiving an email message including the requested data, and posting the received requested data to a database.

The data entry form may provide interactive entry of data into the data entry form. The data entry form may be created using at least one of a standard or proprietary document language, a script language, or a programming language. The data entry form may be created using at least one of hypertext markup language, extensible markup language, Java, or Javascript.

The data entry form may provide interactive entry of data into the data entry form in a data entry system while the data entry system is not communicatively connected. The data entry form may be created using at least one of a standard or proprietary document language, a script language, or a programming language. The data entry form may be created using at least one of hypertext markup language, extensible markup language, Java, or Javascript.

The step of building a data entry form may comprise the step of building a data entry form for entering requested data defined by the dataset for the participant in the data collection process. The step of selecting a participant in the data collection process may comprise the step of selecting a plurality of participants in the data collection process. The step of building a data entry form may comprise the step of building a data entry form for entering requested data defined by the dataset for each participant in the data collection process. The step of generating an email message including the data entry form may comprise the step of generating an email message including the data entry form for each participant in the data collection process. The step of transmitting the email message may comprise the step of transmitting a data entry form to each participant in the data collection process. The step of receiving an email message including the requested data may comprise the step of receiving an email message including the requested data for each participant in the data collection process.

Each data entry form may provide interactive entry of data into the data entry form. Each data entry form may be created using at least one of a standard or proprietary document language, a script language, or a programming language. Each data entry form may be created using at least one of hypertext markup language, extensible markup language, Java, or Javascript. Each data entry form may provide interactive entry of data into the data entry form in a data entry system while the data entry system is not communicatively connected. Each data entry form may be created using at least one of a standard or proprietary document language, a script language, or a programming language. Each data entry form may be created using at least one of hypertext markup language, extensible markup language, Java, or Javascript.

In one embodiment, a process for creation of a job candidate interview evaluation, according to the present invention, comprises the steps of creating a job model including a plurality of competencies defining qualifications and skill relating to a position in an organization, selecting an evaluation set including a candidate for the position, a reviewer, and a date of an interview, building a data entry form for entering requested data based on the created job model, generating an email message including the data entry form, transmitting the email message, receiving an email message including the requested data, and posting the received requested data to a database.

The data entry form may provide interactive entry of data into the data entry form. The data entry form may be created using at least one of a standard or proprietary document language, a script language, or a programming language. The data entry form may be created using at least one of hypertext markup language, extensible markup language, Java, or Javascript.

The data entry form may provide interactive entry of data into the data entry form in a data entry system while the data entry system is not communicatively connected. The data entry form may be created using at least one of a standard or proprietary document language, a script language, or a programming language. The data entry form may be created using at least one of hypertext markup language, extensible markup language, Java, or Javascript. The step of building a data entry form may comprise the step of building a data entry form for entering requested data defined by the dataset for the participant in the data collection process. The step of selecting a participant in the data collection process may comprise the step of selecting a plurality of participants in the data collection process. The step of building a data entry form may comprise the step of building a data entry form for entering requested data defined by the dataset for each participant in the data collection process. The step of generating an email message including the data entry form may comprise the step of generating an email message including the data entry form for each participant in the data collection process. The step of transmitting the email message may comprise the step of transmitting a data entry form to each participant in the data collection process. The step of receiving an email message including the requested data may comprise the step of receiving an email message including the requested data for each participant in the data collection process.

Each data entry form may provide interactive entry of data into the data entry form. Each data entry form may be created using at least one of a standard or proprietary document language, a script language, or a programming language. Each data entry form may be created using at least one of hypertext markup language, extensible markup language, Java, or Javascript. Each data entry form may provide interactive entry of data into the data entry form in a data entry system while the data entry system is not communicatively connected. Each data entry form may be created using at least one of a standard or proprietary document language, a script language, or a programming language. Each data entry form may be created using at least one of hypertext markup language, extensible markup language, Java, or Javascript.

In one embodiment, a process for creation of a performance review, according to the present invention, comprises the steps of creating a job model including a plurality of competencies defining qualifications and skill relating to a position in an organization, selecting an evaluation set including a person to be reviewed, a reviewer, and a date of the review, building a data entry form for entering requested data based on the created job model, generating an email message including the data entry form, transmitting the email message, receiving an email message including the requested data, and posting the received requested data to a database.

The data entry form may provide interactive entry of data into the data entry form. The data entry form may be created using at least one of a standard or proprietary document language, a script language, or a programming language. The data entry form may be created using at least one of hypertext markup language, extensible markup language, Java, or Javascript.

The data entry form may provide interactive entry of data into the data entry form in a data entry system while the data entry system is not communicatively connected. The data entry form may be created using at least one of a standard or proprietary document language, a script language, or a programming language. The data entry form may be created using at least one of hypertext markup language, extensible markup language, Java, or Javascript.

The step of building a data entry form may comprise the step of building a data entry form for entering requested data defined by the dataset for the participant in the data collection process. The step of selecting a participant in the data collection process may comprise the step of selecting a plurality of participants in the data collection process. The step of building a data entry form may comprise the step of building a data entry form for entering requested data defined by the dataset for each participant in the data collection process. The step of generating an email message including the data entry form may comprise the step of generating an email message including the data entry form for each participant in the data collection process. The step of transmitting the email message may comprise the step of transmitting a data entry form to each participant in the data collection process. The step of receiving an email message including the requested data may comprise the step of receiving an email message including the requested data for each participant in the data collection process.

Each data entry form may provide interactive entry of data into the data entry form. Each data entry form may be created using at least one of a standard or proprietary document language, a script language, or a programming language. Each data entry form may be created using at least one of hypertext markup language, extensible markup language, Java, or Javascript. Each data entry form may provide interactive entry of data into the data entry form in a data entry system while the data entry system is not communicatively connected. Each data entry form may be created using at least one of a standard or proprietary document language, a script language, or a programming language. Each data entry form may be created using at least one of hypertext markup language, extensible markup language, Java, or Javascript.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary block diagram of a system in which the present invention may be implemented.

FIG. 2 is an exemplary block diagram of a data processing system shown in FIG. 1.

FIG. 3 is a block diagram of an exemplary offline data entry system, in which the present invention may be implemented.

FIG. 4 is an exemplary flow diagram of one embodiment of a data collection process, according to the present invention.

FIG. 5 is an exemplary flow diagram of one embodiment of a data collection process, according to the present invention.

FIG. 6 is an exemplary flow diagram of one embodiment of a data collection process, according to the present invention.

FIG. 7 is an exemplary flow diagram of one embodiment of a data collection process, according to the present invention.

### DETAILED DESCRIPTION OF THE INVENTION

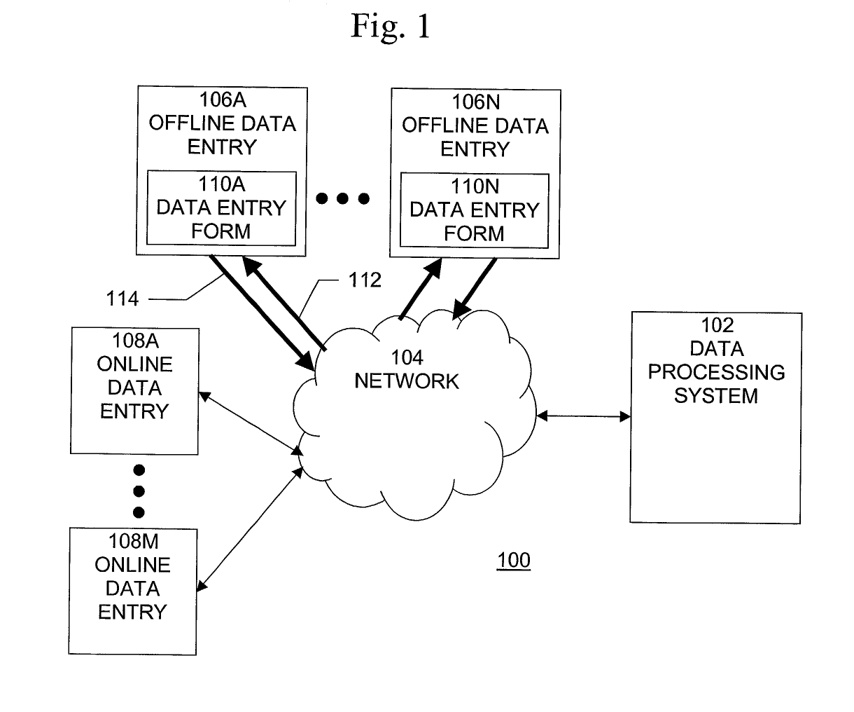

An exemplary block diagram of a system 100, in which the present invention may be implemented, is shown in FIG. 1. System 100 includes data processing system 102, network 104, a plurality of offline data entry systems, such as offline data entry systems 106A-106N, and may include one or more online data entry systems, such as online data entry systems 108A-108M. Data processing system is typically one or more computer systems that accept and process data using one or more application programs that run on data processing system 102. Data processed by data processing system 102 may be obtained from a variety of sources. For example, data may be collected in an automated fashion from other data processing systems. However, data processing system 102 obtains data entered using offline data entry systems 106A-106N and may obtain data entered using online data entry systems 108A-108M. Network 104 includes one or more data communications networks such as a public data communications network, for example, the Internet, or a private data communications network, for example, a private intranet.

Online data entry systems 108A-108M are typically computer systems or terminals that provide the capability for a user to enter data into one or more applications running in data processing system 102, while the online data entry systems are communicatively connected to data processing system 102, either directly or via network 104. Offline data entry systems 106A-106N are typically computer systems that provide the capability to enter data into the offline data entry system, whether or not the offline data entry system is communicatively connected to data processing system 102. In particular, a data entry form, such as data entry form 110A, is transmitted from data processing system 102 to an offline data entry system, such as offline data entry system 106A, preferably in an email message 112. The data entry form may be filled-in by the user of the offline data entry system at any time, regardless of whether or not the offline data entry system is communicatively connected to data processing system 102. When the data entry form, such as data entry form 110A, is completed, the data is extracted from the form and may be transmitted to data processing system 102 at any convenient time. Preferably, the extracted data is transmitted from the offline data entry system, such as offline data entry system 106A, to data processing system 102, in an email message 114.

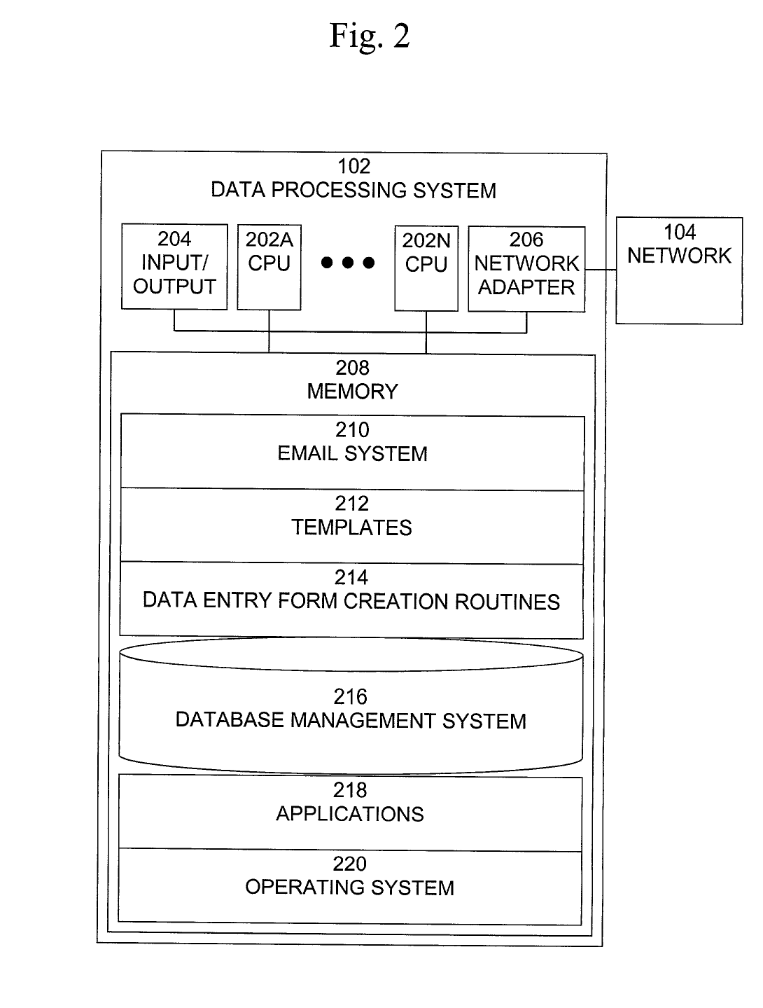

An exemplary block diagram of a data processing system 200, shown in FIG. 1, is shown in FIG. 2. System 200 is typically a programmed general-purpose computer system, such as a personal computer, workstation, server system, and minicomputer or mainframe computer. System 200 includes one or more processors (CPUs) 202A-302N, input/output circuitry 204, network adapter 206, and memory 208. CPUs 202A-302N execute program instructions in order to carry out the functions of the present invention. Typically, CPUs 202A-202N are one or more microprocessors, such as an INTEL PENTIUM® processor. FIG. 2 illustrates an embodiment in which system 200 is implemented as a single multi-processor computer system, in which multiple processors 202A-202N share system resources, such as memory 208, input/output circuitry 204, and network adapter 206. However, the present invention also contemplates embodiments in which system 200 is implemented as a plurality of networked computer systems, which may be single-processor computer systems, multi-processor computer systems, or a mix thereof.

Input/output circuitry 204 provides the capability to input data to, or output data from, system 200. For example, input/output circuitry may include input devices, such as keyboards, mice, touchpads, trackballs, scanners, etc., output devices, such as video adapters, monitors, printers, etc., and input/output devices, such as, modems, etc. Network adapter 206 interfaces system 200 with network 104. Network 104 may include one or more standard local area network (LAN) or wide area network (WAN), such as Ethernet, Token Ring, the Internet, or a private or proprietary LAN/WAN.

Memory 208 stores program instructions that are executed by, and data that are used and processed by, CPUs 202A-202N to perform the functions of system 200. Memory 208 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

Memory 208 includes email system 210, templates 212, data entry form creation routines 214, database 216, applications 218, and operating system 220. Email system 210 includes software that implements the email transmission and reception functionality. This functionality includes generating email messages including data entry forms, transmitting the generated email messages to the specified recipients, and receiving email messages including completed data entry forms. Templates 212 include information specifying formats, layouts, data fields, and designs for data entry forms that may be generated. A template may specify a complete data entry form, a portion of a data entry form, or a combination of other templates that may be assembled to create a complete data entry form. Data entry form creation routines generate data entry forms based on input from a user who is designing a data entry form. The user may specify one or more templates to be used to generate the data entry form, and/or the user may specify other formats, layouts, data fields, and designs for the data entry forms that will be generated.

Database management system (DBMS) 216 provides the capability to store, organize, modify, and extract the data collected using the data entry forms. From a technical standpoint, DBMSs can differ widely. The terms relational, network, flat, and hierarchical all refer to the way a DBMS organizes information internally. The internal organization can affect how quickly and flexibly information can be extracted.

The database includes a collection of information organized in such a way that computer software can select and retrieve desired pieces of data. Traditional databases are organized by fields, records, and files. A field is a single piece of information; a record is one complete set of fields; and a file is a collection of records. An alternative concept in database design is known as Hypertext. In a Hypertext database, any object, whether it be a piece of text, a picture, or a film, can be linked to any other object. Hypertext databases are particularly useful for organizing large amounts of disparate information, but they are not designed for numerical analysis.

Typically, a DBMS includes not only data, but also low-level database management functions, which perform accesses to the database and store or retrieve data from the database. Such functions are often termed queries and are performed by using a database query language, such as structured query language (SQL). SQL is a standardized query language for requesting information from a database. Historically, SQL has been a popular query language for database management systems running on minicomputers and mainframes. Increasingly, however, SQL is being supported by personal computer database systems because it supports distributed databases (databases that are spread out over several computer systems). This enables several users on a local-area network to access the same database simultaneously.

Most full-scale database systems are relational database systems. Small database systems, however, use other designs that provide less flexibility in posing queries. Relational databases are powerful because they require few assumptions about how data is related or how it will be extracted from the database. As a result, the same database can be viewed in many different ways. An important feature of relational systems is that a single database can be spread across several tables. This differs from flat-file databases, in which each database is self-contained in a single table.

Applications 218 include a variety of software programs that implement business processes or other data processing functions. For example, applications 218 may include applications that implement business processes such as performance reviews, project participant selection, project staffing selection, participant competency prioritization, etc.

Operating system 228 provides overall system functionality.

As shown in FIG. 2, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and WINDOWS®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multitasking computing, as the terms task and process are often used interchangeably, although some operating systems make a distinction between the two.

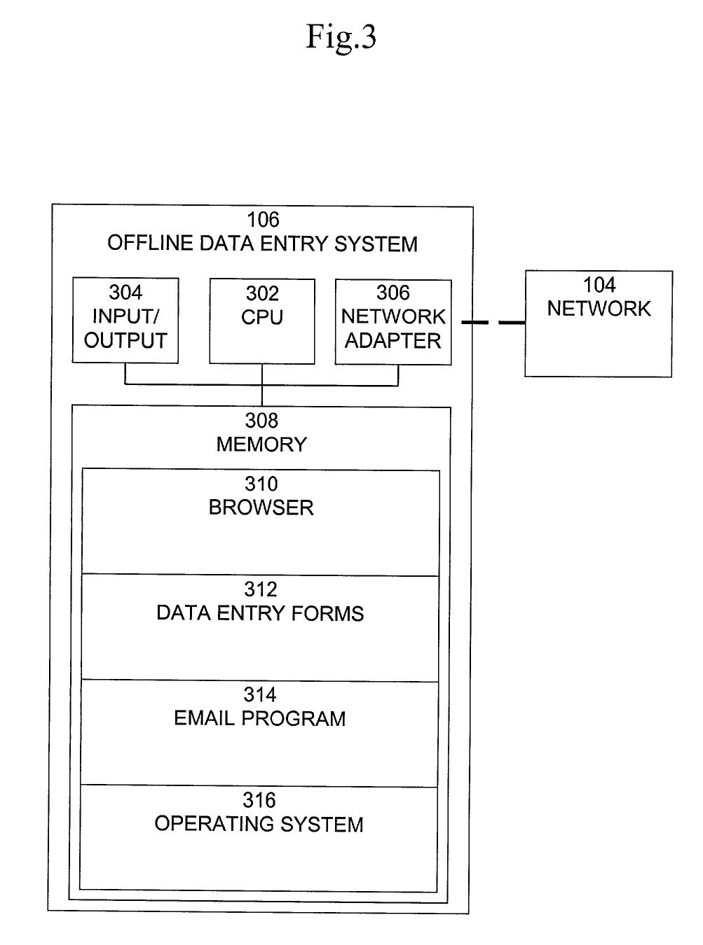

A block diagram of an exemplary offline data entry system 106, in which the present invention may be implemented, is shown in FIG. 3. Offline data entry system 106 is typically a programmed general-purpose computer system, such as a personal computer, workstation, server system, and minicomputer or mainframe computer. Offline data entry system 106 includes processor (CPU) 302, input/output circuitry 304, network adapter 306, and memory 308. CPU 302 executes program instructions in order to carry out the functions of the present invention. Typically, CPU 302 is a microprocessor, such as an INTEL PENTIUM® processor, but may also be a minicomputer or mainframe computer processor. Although in the example shown in FIG. 3, computer system 300 is a single processor computer system, the present invention contemplates implementation on a system or systems that provide multi-processor, multi-tasking, multi-process, multi-thread computing, distributed computing, and/or networked computing, as well as implementation on systems that provide only single processor, single thread computing. Likewise, the present invention also contemplates embodiments that utilize a distributed implementation, in which computer system 300 is implemented on a plurality of networked computer systems, which may be single-processor computer systems, multi-processor computer systems, or a mix thereof.

Input/output circuitry 304 provides the capability to input data to, or output data from, computer system 300. For example, input/output circuitry may include input devices, such as keyboards, mice, touchpads, trackballs, scanners, etc., output devices, such as video adapters, monitors, printers, etc., and input/output devices, such as, modems, etc. Network adapter 306 interfaces computer system 300 with network 104. Network 104 may be any standard local area network (LAN) or wide area network (WAN), such as Ethernet, Token Ring, the Internet, or a private or proprietary LAN/WAN. The connection between network adapter 306 and network 104 is not necessarily continuous. In particular, offline data entry system 106 is offline when there is no communicative connection between system 106 and network 104. For example, at times, system 106 may not be logged on to network 104, or system 106 may not even be physically connected to network 104.

Memory 308 stores program instructions that are executed by, and data that are used and processed by, CPU 302 to perform the functions of the present invention. Memory 308 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

Memory 308 includes browser program 310, data entry forms 312, email program 314 and operating system 316. Browser 310 is a software application used to locate and display Web and other interactive pages and documents. Preferably, browser 310 is a graphical browser, which can display graphics as well as text and, in addition, present multimedia information, including sound and video. Examples of programs suitable for browser 310 include Netscape Navigator® and Microsoft Internet Explorer®. Browser 310 typically displays pages or documents that use hypertext markup language (HTML), but, when properly configured, may also display pages or documents using any standard or proprietary document language, script language, or programming language. For example, browser 310 may display pages or documents that include extensible markup language (XML) code, JAVA® code, or JAVASCRIPT® code. Such scripting and programming languages provide the capability to create pages or documents including advanced interactive features and advanced processing functions.

Data entry forms 312 include pages or documents that may be displayed by browser 310 that provide the capability to interact with a person who enters data into the data entry form. Data entry forms may be created using any standard or proprietary document language, script language, or programming language that is compatible with browser 310. For example, data entry forms 312 may be created using HTML or XML code, but JAVA® or JAVASCRIPT® are preferred because they provide the capability for advanced interactive features and advanced processing functions.

Email program 314 includes software that implements the email transmission and reception functionality. This functionality includes receiving email messages including data entry forms, storing or filing the received data entry forms, and transmitting the compiled data that was entered into the data entry forms.

Operating system 316 provides overall system functionality.

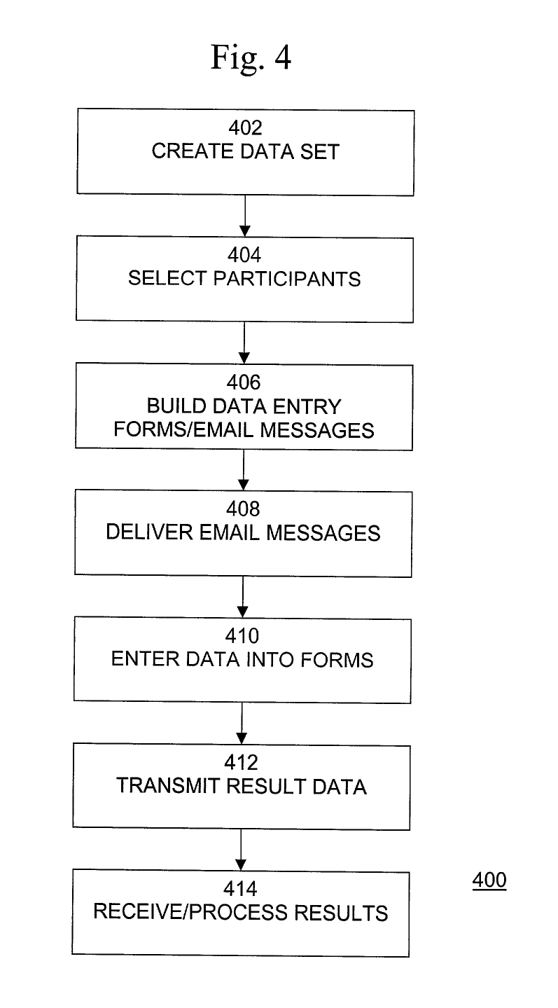

An exemplary flow diagram of a data collection process 400 is shown in FIG. 4. Process 400 begins with step 402, in which the data set is created. In order to create a data set, a user determines what kind of data is to be collected. Preferably, the user may select a predefined data set that corresponds to the data needed for the project the user seeks to perform. For example, predefined data sets may be available for performance appraisals, staffing applications, job models, etc. The user may modify predefined data sets to customize them for particular applications. If necessary, the user may even create a custom data set.

In step 404, the user selects the participants in the data collection project. Participants are individuals who will receive and complete data entry forms. Preferably, this step may be performed automatically using predefinitions or data that specifies relationships between individuals. For example, in a performance appraisal application, those individuals whose input to the performance appraisal is required may be automatically determined once the particular position for which the performance appraisal is to be performed is specified. In other cases, some or all of the participants must be specified by the user.

In step 406, the data entry forms incorporating the selected and defined data sets are created for the selected participants. The data entry forms are pages or documents that provide the capability for a participant to enter requested data. Some data may simply require the participant to select from among several choices. Some data may be pre-filled in, while allowing the participant the opportunity to modify the data. Other data must be entirely entered by the participant. In addition, in many cases, the data entry forms for each participant may be similar or identical, but in other cases, the data entry forms for each participant must be customized for that participant.

The data entry forms are encapsulated as email messages and addressed to the selected participants. These messages are sent to the email system and queued for transmission to the participants.

In step 408, the email messages are delivered to the data entry systems in use by the participants. The data entry forms are extracted from the email messages and displayed to each participant, typically using a browser program. Each message may include an instructional cover page and a data entry form that the reviewer will fill-in.

In step 410, the participants enter the requested data into the data entry forms. The data entry forms can be filled-in by the participants at their convenience. The data entry forms may be filled-in either online or offline. It is not necessary to be online, connected to a network, such as the Internet, in order to fill in the data entry forms.

In step 412, the result data is transmitted to the data processing system. When a participant has finished filling-in a data entry form, the participant transmits the result data to the data processing system, preferably as an email message. This email message is automatically generated by the data entry form. The result data may include the raw data entered by the participant into the data entry form. The result data may also include processed data that was generated by the data entry form based on the data entered by the participant into the data entry form.

In step 414, the data processing system receives and processes the result data. The email system of the data processing system repeatedly polls to determine whether any new email messages have arrived. If so, the messages are checked for validity and the result data is extracted. The result data is processed, if necessary and posted to the database. Once posted to the database, the result data is available to authorized users.

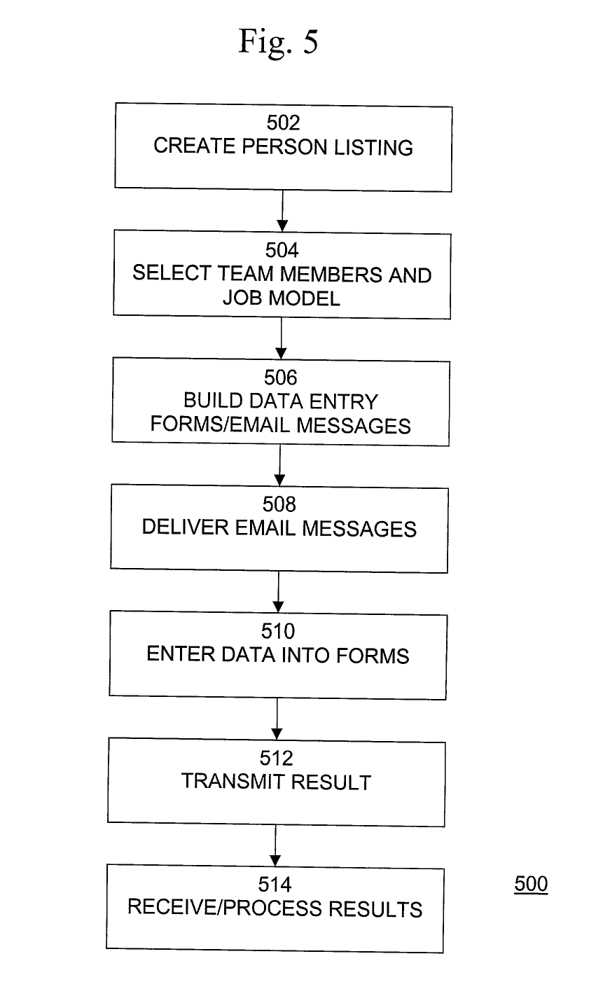

An exemplary flow diagram of a data collection process 500 is shown in FIG. 5. Process 500 is an embodiment of process 400 that is directed to collaborative creation of descriptions of competencies related to a position defined by a job model. Process 500 begins with step 502, in which a person listing is created. In order to create a person listing, information relating to potential participants and available types of job models are displayed to a user.

In step 504, the user selects the participants, who will be the team members for the project and who will receive and complete data entry forms. The user also selects a job model that will define the position about which competency data will be collected.

In step 506, the data entry forms incorporating the selected and defined job model are created for the selected participants. The data entry forms are pages or documents that provide the capability for a participant to enter requested data. Some data may simply require the participant to select from among several choices. Some data may be pre-filled in, while allowing the participant the opportunity to modify the data. Other data must be entirely entered by the participant. In addition, in many cases, the data entry forms for each participant may be similar or identical, but in other cases, the data entry forms for each participant must be customized for that participant.

The data entry forms are encapsulated as email messages and addressed to the selected participants. These messages are sent to the email system and queued for transmission to the participants.

In step 508, the email messages are delivered to the data entry systems in use by the participants. The data entry forms are extracted from the email messages and displayed to each participant, typically using a browser program. Each message may include an instructional cover page and a data entry form that the reviewer will fill-in.

In step 510, the participants enter the requested data into the data entry forms. The data entry forms can be filled-in by the participants at their convenience. The data entry forms may be filled-in either online or offline. It is not necessary to be online, connected to a network, such as the Internet, in order to fill in the data entry forms. In particular, the participants enter information relating to competencies, such as qualifications and skills, which are required or desirable for position defined by the selected job model.

In step 512, the result data is transmitted to the data processing system. When a participant has finished filling-in a data entry form, the participant transmits the result data to the data processing system, preferably as an email message. This email message is automatically generated by the data entry form. The result data may include the raw data entered by the participant into the data entry form. The result data may also include processed data that was generated by the data entry form based on the data entered by the participant into the data entry form.

In step 514, the data processing system receives and processes the result data. The email system of the data processing system repeatedly polls to determine whether any new email messages have arrived. If so, the messages are checked for validity and the result data is extracted. The result data is processed, if necessary and posted to the database. Once posted to the database, the result data is available to authorized users. In addition, the received results may be used to dynamically assign weights to each of the competencies that are related to the position defined by selected job model.

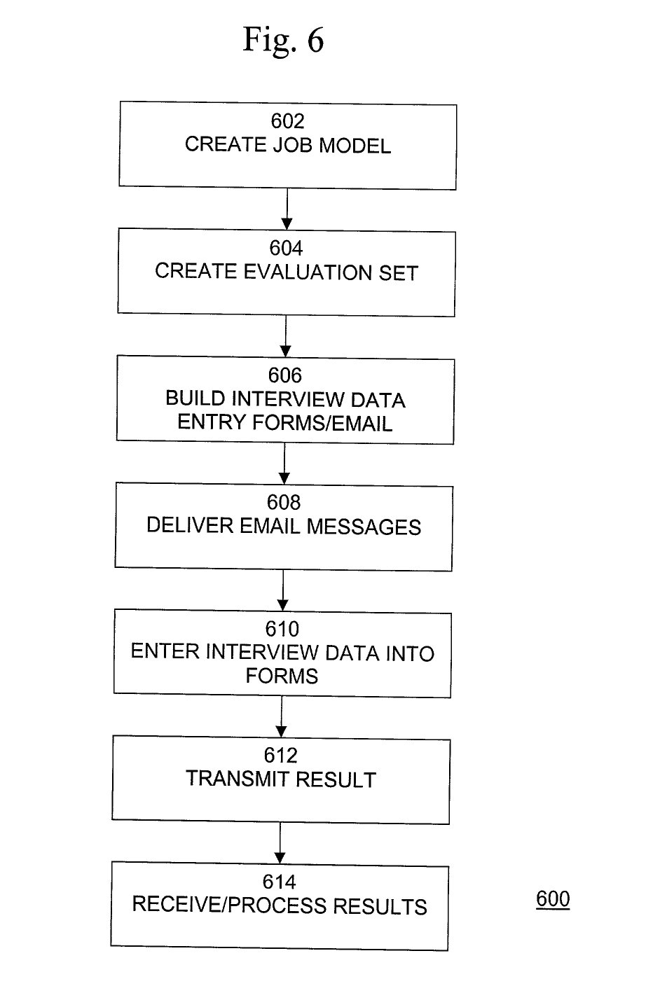

An exemplary flow diagram of a data collection process 600 is shown in FIG. 6. Process 600 is an embodiment of process 400 that is directed to creation of a job candidate interview evaluation. Process 600 begins with step 602, in which the job model is created. A job model is a collection of competencies that define required and desirable qualifications and skills related to a position in an organization. In order to create a job model, a user determines the competencies that are relevant to the position, which will determine the kind of data that is to be collected in the interview of the candidate. Preferably, the user may select a predefined job model that corresponds to the position. For example, predefined job models may be available for management positions, individual contributors, etc. The user may modify predefined job models to customize them for particular applications. If necessary, the user may even create a custom job model.

In step 604, the user selects the evaluation set, which includes the participants in the interview. In particular, the evaluation set includes the candidate for the position who is to be interviewed, the reviewers, each of whom will conduct an interview with the candidate and each of whom will enter the data, and the date of each interview between the candidate and a reviewer.

In step 606, the data entry forms incorporating the selected and defined data sets are created for the selected reviewers. The data entry forms are pages or documents that provide the capability for a reviewer to enter requested data. The necessary information is extracted from the relevant databases and incorporated to generate the data entry forms. Some data to be entered may simply require the reviewer to select from among several choices. Some data may be pre-filled in, while allowing the reviewer the opportunity to modify the data. Other data must be entirely entered by the reviewer. In addition, in many cases, the data entry forms for each reviewer may be similar or identical, but in other cases, the data entry forms for each reviewer must be customized for that reviewer.

The data entry forms are encapsulated as email messages and addressed to the selected reviewers. These messages are sent to the email system and queued for transmission to the reviewers. The defined date of the interview is used as a “send on” date to control the date on which the data entry forms are transmitted to the reviewers.

In step 608, the email messages are delivered to the data entry systems in use by the reviewers. The data entry forms are extracted from the email messages and displayed to each reviewer, typically using a browser program. Each reviewer will receive a message indicating that it is time to enter interview data for the specified candidate. Each message may include an instructional cover page and a data entry form that the reviewer will fill-in.

In step 610, the reviewers enter the requested data into the data entry forms. The data entry forms can be filled-in by the reviewers at their convenience. The data entry forms may be filled-in either online or offline. It is not necessary to be online, connected to a network, such as the Internet, in order to fill in the data entry forms.

In step 612, the result data is transmitted to the data processing system. When a reviewer has finished filling-in a data entry form, the reviewer transmits the result data to the data processing system, preferably as an email message. This email message is automatically generated by the data entry form. The result data may include the raw data entered by the reviewer into the data entry form. The result data may also include processed data that was generated by the data entry form based on the data entered by the reviewer into the data entry form.

In step 614, the data processing system receives and processes the result data. The email system of the data processing system repeatedly polls to determine whether any new email messages have arrived. If so, the messages are checked for validity and the result data is extracted. The result data is processed, if necessary and posted to the database that originated the process. Once posted to the database, the result data is available to authorized users.

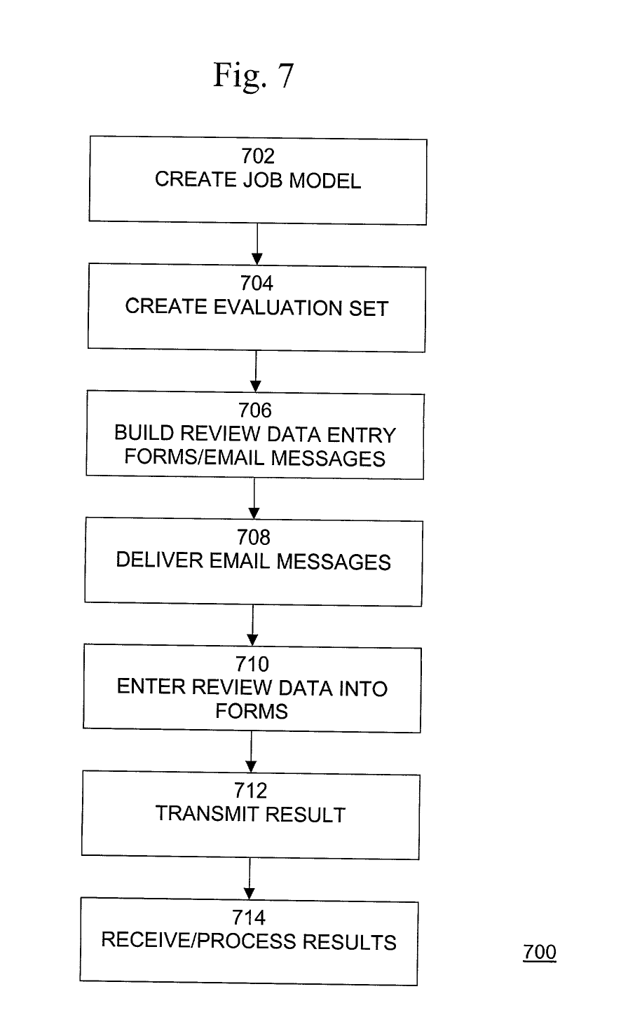

An exemplary flow diagram of a data collection process 700 is shown in FIG. 7. Process 700 is an embodiment of process 400 that is directed to creation of a performance review. Process 700 begins with step 702, in which the job model is created. A job model is a collection of competencies that define required and desirable qualifications and skills related to a position in an organization. In order to create a job model, a user determines the competencies that are relevant to the position, which will determine the kind of data that is to be collected in the review. Preferably, the user may select a predefined job model that corresponds to the position. For example, predefined job models may be available for management positions, individual contributors, etc. The user may modify predefined job models to customize them for particular applications. If necessary, the user may even create a custom job model.

In step 704, the user selects the evaluation set, which includes the participants in the review. In particular, the evaluation set includes the person who is to be reviewed, the reviewers, each of whom would perform a review of the person and each of whom will enter the data, and the date of each review.

In step 706, the data entry forms incorporating the selected and defined data sets are created for the selected reviewers. The data entry forms are pages or documents that provide the capability for a reviewer to enter requested data. The necessary information is extracted from the relevant databases and incorporated to generate the data entry forms. Some data to be entered may simply require the reviewer to select from among several choices. Some data may be pre-filled in, while allowing the reviewer the opportunity to modify the data. Other data must be entirely entered by the reviewer. In addition, in many cases, the data entry forms for each reviewer may be similar or identical, but in other cases, the data entry forms for each reviewer must be customized for that reviewer.

The data entry forms are encapsulated as email messages and addressed to the selected reviewers. These messages are sent to the email system and queued for transmission to the reviewers.

In step 708, the email messages are delivered to the data entry systems in use by the reviewers. The data entry forms are extracted from the email messages and displayed to each reviewer, typically using a browser program. Each reviewer will receive a message indicating that it is time to enter review data for the specified person. Each message may include an instructional cover page and a data entry form that the reviewer will fill-in.

In step 710, the reviewers enter the requested data into the data entry forms. The data entry forms can be filled-in by the reviewers at their convenience. The data entry forms may be filled-in either online or offline. It is not necessary to be online, connected to a network, such as the Internet, in order to fill in the data entry forms.

In step 712, the result data is transmitted to the data processing system. When a reviewer has finished filling-in a data entry form, the reviewer transmits the result data to the data processing system, preferably as an email message. This email message is automatically generated by the data entry form. The result data may include the raw data entered by the reviewer into the data entry form. The result data may also include processed data that was generated by the data entry form based on the data entered by the reviewer into the data entry form.

In step 714, the data processing system receives and processes the result data. The email system of the data processing system repeatedly polls to determine whether any new email messages have arrived. If so, the messages are checked for validity and the result data is extracted. The result data is processed, if necessary and posted to the database that originated the process. Once posted to the database, the result data is available to authorized users. It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A data collection process comprising the steps of:
building a data entry form for entering requested data;
generating an email message including the data entry form;
transmitting the email message;
receiving an email message including the requested data; and
posting the received requested data to a database.

2. The data collection process of claim 1, wherein the data entry form provides interactive entry of data into the data entry form.

3. The data collection process of claim 2, wherein the data entry form is created using at least one of a standard or proprietary document language, a script language, or a programming language.

4. The data collection process of claim 2, wherein the data entry form is created using at least one of hypertext markup language, extensible markup language, Java, or Javascript.

5. The data collection process of claim 1, wherein the data entry form provides interactive entry of data into the data entry form in a data entry system while the data entry system is not communicatively connected.

6. The data collection process of claim 5, wherein the data entry form is created using at least one of a standard or proprietary document language, a script language, or a programming language.

7. The data collection process of claim 6, wherein the data entry form is created using at least one of hypertext markup language, extensible markup language, Java, or Javascript.

8. The data collection process of claim 1, further comprising the steps of:
creating a dataset defining data that is to be collected; and
selecting a participant in the data collection process.

9. The data collection process of claim 8, wherein the step of building a data entry form comprises the step of:
building a data entry form for entering requested data defined by the dataset for the participant in the data collection process.

10. The data collection process of claim 8, wherein the step of selecting a participant in the data collection process comprises the step of:
selecting a plurality of participants in the data collection process.

11. The data collection process of claim 10, wherein the step of building a data entry form comprises the step of:
building a data entry form for entering requested data defined by the dataset for each participant in the data collection process.

12. The data collection process of claim 11, wherein the step of generating an email message including the data entry form comprises the step of:
generating an email message including the data entry form for each participant in the data collection process.

13. The data collection process of claim 12, wherein the step of transmitting the email message comprises the step of:
transmitting a data entry form to each participant in the data collection process.

14. The data collection process of claim 13, wherein the step of receiving an email message including the requested data comprises the step of:
receiving an email message including the requested data for each participant in the data collection process.

15. The data collection process of claim 14, wherein each data entry form provides interactive entry of data into the data entry form.

16. The data collection process of claim 15, wherein each data entry form is created using at least one of a standard or proprietary document language, a script language, or a programming language.

17. The data collection process of claim 15, wherein each data entry form is created using at least one of hypertext markup language, extensible markup language, Java, or Javascript.

18. The data collection process of claim 14, wherein each data entry form provides interactive entry of data into the data entry form in a data entry system while the data entry system is not communicatively connected.

19. The data collection process of claim 18, wherein each data entry form is created using at least one of a standard or proprietary document language, a script language, or a programming language.

20. The data collection process of claim 18, wherein each data entry form is created using at least one of hypertext markup language, extensible markup language, Java, or Javascript.

21. A data collection process in a data entry system comprising the steps of:
receiving an email message including a data entry form requesting data;
extracting the data entry form from the email message;
interactively entering the requested data into the data entry form; and
transmitting an email message including the entered data.

22. The data collection process of claim 21, further comprising the step of:
displaying the data entry form.

23. The data collection process of claim 22, wherein the data entry form is created using at least one of a standard or proprietary document language, a script language, or a programming language.

24. The data collection process of claim 22, wherein the data entry form is created using at least one of hypertext markup language, extensible markup language, Java, or Javascript.

25. The data collection process of claim 21, further comprising the step of:
displaying the data entry form using a browser program.

26. The data collection process of claim 25, wherein the data entry form is created using at least one of a standard or proprietary document language, a script language, or a programming language.

27. The data collection process of claim 25, wherein the data entry form is created using at least one of hypertext markup language, extensible markup language, Java, or Javascript.

28. The data collection process of claim 21, wherein the step of interactively entering the requested data into the data entry form comprises the step of:
interactively entering the requested data into the data entry form while the data entry system is not communicatively connected.

29. The data collection process of claim 28, further comprising the step of:
displaying the data entry form.

30. The data collection process of claim 29, wherein the data entry form is created using at least one of a standard or proprietary document language, a script language, or a programming language.

31. The data collection process of claim 29, wherein the data entry form is created using at least one of hypertext markup language, extensible markup language, Java, or Javascript.

32. The data collection process of claim 28, further comprising the step of:
displaying the data entry form using a browser program.

33. The data collection process of claim 32, wherein the data entry form is created using at least one of a standard or proprietary document language, a script language, or a programming language.

34. The data collection process of claim 32, wherein the data entry form is created using at least one of hypertext markup language, extensible markup language, Java, or Javascript.

35. A process for collaborative creation of descriptions of competencies related to a position defined by a job model comprising the steps of:
creating a person listing including information relating to potential participants and available types of job models;
selecting a participant and a job model;
building a data entry form for entering requested data based on the selected job model;
generating an email message including the data entry form;
transmitting the email message;
receiving an email message including the requested data; and
posting the received requested data to a database.

36. The process of claim 35, wherein the data entry form provides interactive entry of data into the data entry form.

37. The process of claim 36, wherein the data entry form is created using at least one of a standard or proprietary document language, a script language, or a programming language.

38. The process of claim 36, wherein the data entry form is created using at least one of hypertext markup language, extensible markup language, Java, or Javascript.

39. The process of claim 35, wherein the data entry form provides interactive entry of data into the data entry form in a data entry system while the data entry system is not communicatively connected.

40. The process of claim 39, wherein the data entry form is created using at least one of a standard or proprietary document language, a script language, or a programming language.

41. The process of claim 40, wherein the data entry form is created using at least one of hypertext markup language, extensible markup language, Java, or Javascript.

42. The process of claim 35, wherein the step of building a data entry form comprises the step of:
building a data entry form for entering requested data defined by the dataset for the participant in the data collection process.

43. The process of claim 42, wherein the step of selecting a participant comprises the step of:
selecting a plurality of participants in the data collection process.

44. The process of claim 43, wherein the step of building a data entry form comprises the step of:
building a data entry form for entering requested data defined by the dataset for each participant in the data collection process.

45. The process of claim 44, wherein the step of generating an email message including the data entry form comprises the step of: generating an email message including the data entry form for each participant in the data collection process.

46. The process of claim 45, wherein the step of transmitting the email message comprises the step of:
transmitting a data entry form to each participant in the data collection process.

47. The process of claim 46, wherein the step of receiving an email message including the requested data comprises the step of:
receiving an email message including the requested data for each participant in the data collection process.

48. The process of claim 47, wherein each data entry form provides interactive entry of data into the data entry form.

49. The process of claim 48, wherein each data entry form is created using at least one of a standard or proprietary document language, a script language, or a programming language.

50. The process of claim 48, wherein each data entry form is created using at least one of hypertext markup language, extensible markup language, Java, or Javascript.

51. The process of claim 47, wherein each data entry form provides interactive entry of data into the data entry form in a data entry system while the data entry system is not communicatively connected.

52. The process of claim 51, wherein each data entry form is created using at least one of a standard or proprietary document language, a script language, or a programming language.

53. The process of claim 51, wherein each data entry form is created using at least one of hypertext markup language, extensible markup language, Java, or Javascript.

54. A process for creation of a job candidate interview evaluation comprising the steps of:
creating a job model including a plurality of competencies defining qualifications and skill relating to a position in an organization;
selecting an evaluation set including a candidate for the position, a reviewer, and a date of an interview;
building a data entry form for entering requested data based on the created job model;
generating an email message including the data entry form;
transmitting the email message;
receiving an email message including the requested data; and
posting the received requested data to a database.

55. The process of claim 54, wherein the data entry form provides interactive entry of data into the data entry form.

56. The process of claim 55, wherein the data entry form is created using at least one of a standard or proprietary document language, a script language, or a programming language.

57. The process of claim 55, wherein the data entry form is created using at least one of hypertext markup language, extensible markup language, Java, or Javascript.

58. The process of claim 54, wherein the data entry form provides interactive entry of data into the data entry form in a data entry system while the data entry system is not communicatively connected.

59. The process of claim 58, wherein the data entry form is created using at least one of a standard or proprietary document language, a script language, or a programming language.

60. The process of claim 59, wherein the data entry form is created using at least one of hypertext markup language, extensible markup language, Java, or Javascript.

61. The process of claim 54, wherein the step of building a data entry form comprises the step of:
building a data entry form for entering requested data defined by the dataset for the participant in the data collection process.

62. The process of claim 61, wherein the step of selecting a participant comprises the step of:
selecting a plurality of participants in the data collection process.

63. The process of claim 62, wherein the step of building a data entry form comprises the step of:
building a data entry form for entering requested data defined by the dataset for each participant in the data collection process.

64. The process of claim 63, wherein the step of generating an email message including the data entry form comprises the step of:
generating an email message including the data entry form for each participant in the data collection process.

65. The process of claim 64, wherein the step of transmitting the email message comprises the step of:
transmitting a data entry form to each participant in the data collection process.

66. The process of claim 65, wherein the step of receiving an email message including the requested data comprises the step of:
receiving an email message including the requested data for each participant in the data collection process.

67. The process of claim 66, wherein each data entry form provides interactive entry of data into the data entry form.

68. The process of claim 67, wherein each data entry form is created using at least one of a standard or proprietary document language, a script language, or a programming language.

69. The process of claim 67, wherein each data entry form is created using at least one of hypertext mark up language, extensible markup language, Java, or Javascript.

70. The process of claim 66, wherein each data entry form provides interactive entry of data into the data entry form in a data entry system while the data entry system is not communicatively connected.

71. The process of claim 70, wherein each data entry form is created using at least one of a standard or proprietary document language, a script language, or a programming language.

72. The process of claim 70, wherein each data entry form is created using at least one of hypertext markup language, extensible markup language, Java, or Javascript.

73. A process for creation of a performance review comprising the steps of:
creating a job model including a plurality of competencies defining qualifications and skill relating to a position in an organization;
selecting an evaluation set including a person to be reviewed, a reviewer, and a date of the review;
building a data entry form for entering requested data based on the created job model;
generating an email message including the data entry form;
transmitting the email message;
receiving an email message including the requested data; and
posting the received requested data to a database.

74. The process of claim 73, wherein the data entry form provides interactive entry of data into the data entry form.

75. The process of claim 74, wherein the data entry form is created using at least one of a standard or proprietary document language, a script language, or a programming language.

76. The process of claim 74, wherein the data entry form is created using at least one of hypertext markup language, extensible markup language, Java, or Javascript.

77. The process of claim 73, wherein the data entry form provides interactive entry of data into the data entry form in a data entry system while the data entry system is not communicatively connected.

78. The process of claim 77, wherein the data entry form is created using at least one of a standard or proprietary document language, a script language, or a programming language.

79. The process of claim 78, wherein the data entry form is created using at least one of hypertext markup language, extensible markup language, Java, or Javascript.

80. The process of claim 73, wherein the step of building a data entry form comprises the step of:
building a data entry form for entering requested data defined by the dataset for the participant in the data collection process.

81. The process of claim 80, wherein the step of selecting a participant comprises the step of:
selecting a plurality of participants in the data collection process.

82. The process of claim 81, wherein the step of building a data entry form comprises the step of:
building a data entry form for entering requested data defined by the dataset for each participant in the data collection process.

83. The process of claim 82, wherein the step of generating an email message including the data entry form comprises the step of:
generating an email message including the data entry form for each participant in the data collection process.

84. The process of claim 83, wherein the step of transmitting the email message comprises the step of:
transmitting a data entry form to each participant in the data collection process.

85. The process of claim 84, wherein the step of receiving an email message including the requested data comprises the step of:
receiving an email message including the requested data for each participant in the data collection process.

86. The process of claim 85, wherein each data entry form provides interactive entry of data into the data entry form.

87. The process of claim 86, wherein each data entry form is created using at least one of a standard or proprietary document language, a script language, or a programming language.

88. The process of claim 86, wherein each data entry form is created using at least one of hypertext markup language, extensible markup language, Java, or Javascript.

89. The process of claim 85, wherein each data entry form provides interactive entry of data into the data entry form in a data entry system while the data entry system is not communicatively connected.

90. The process of claim 89, wherein each data entry form is created using at least one of a standard or proprietary document language, a script language, or a programming language.

91. The process of claim 89, wherein each data entry form is created using at least one of hypertext markup language, extensible markup language, Java, or Javascript.

92. A system for implementing a data collection process comprising:
a processor operable to execute computer program instructions;
a memory operable to store computer program instructions executable by the processor; and
computer program instructions stored in the memory and executable to perform the steps of:
building a data entry form for entering requested data;
generating an email message including the data entry form;
transmitting the email message;
receiving an email message including the requested data; and
posting the received requested data to a database.

93. The system of claim 92, wherein the data entry form provides interactive entry of data into the data entry form.

94. The system of claim 93, wherein the data entry form is created using at least one of a standard or proprietary document language, a script language, or a programming language.

95. The system of claim 93, wherein the data entry form is created using at least one of hypertext markup language, extensible markup language, Java, or Javascript.

96. The system of claim 92, wherein the data entry form provides interactive entry of data into the data entry form in a data entry system while the data entry system is not communicatively connected.

97. The system of claim 96, wherein the data entry form is created using at least one of a standard or proprietary document language, a script language, or a programming language.

98. The system of claim 97, wherein the data entry form is created using at least one of hypertext markup language, extensible markup language, Java, or Javascript.

99. The system of claim 92, further comprising the steps of:
creating a dataset defining data that is to be collected; and
selecting a participant in the data collection process.

100. The system of claim 99, wherein the step of building a data entry form comprises the step of:
building a data entry form for entering requested data defined by the dataset for the participant in the data collection process.

101. The system of claim 99, wherein the step of selecting a participant in the data collection process comprises the step of:
selecting a plurality of participants in the data collection process.

102. The system of claim 101, wherein the step of building a data entry form comprises the step of:
building a data entry form for entering requested data defined by the dataset for each participant in the data collection process.

103. The system of claim 102, wherein the step of generating an email message including the data entry form comprises the step of:
generating an email message including the data entry form for each participant in the data collection process.

104. The system of claim 103, wherein the step of transmitting the email message comprises the step of:
transmitting a data entry form to each participant in the data collection process.

105. The system of claim 104, wherein the step of receiving an email message including the requested data comprises the step of:
receiving an email message including the requested data for each participant in the data collection process.

106. The system of claim 105, wherein each data entry form provides interactive entry of data into the data entry form.

107. The system of claim 106, wherein each data entry form is created using at least one of a standard or proprietary document language, a script language, or a programming language.

108. The system of claim 107, wherein each data entry form is created using at least one of hypertext markup language, extensible markup language, Java, or Javascript.

109. The system of claim 108, wherein each data entry form provides interactive entry of data into the data entry form in a data entry system while the data entry system is not communicatively connected.

110. The system of claim 109, wherein each data entry form is created using at least one of a standard or proprietary document language, a script language, or a programming language.

111. The system of claim 109, wherein each data entry form is created using at least one of hypertext markup language, extensible markup language, Java, or Javascript.

112. A data entry system for implementing a data collection process comprising:
a processor operable to execute computer program instructions;
a memory operable to store computer program instructions executable by the processor; and
computer program instructions stored in the memory and executable to perform the steps of:
receiving an email message including a data entry form requesting data;
extracting the data entry form from the email message;
interactively entering the requested data into the data entry form; and
transmitting an email message including the entered data.

113. The system of claim 112, further comprising the step of:
displaying the data entry form.

114. The system of claim 113, wherein the data entry form is created using at least one of a standard or proprietary document language, a script language, or a programming language.

115. The system of claim 113, wherein the data entry form is created using at least one of hypertext markup language, extensible markup language, Java, or Javascript.

116. The system of claim 112, further comprising the step of:
displaying the data entry form using a browser program.

117. The system of claim 116, wherein the data entry form is created using at least one of a standard or proprietary document language, a script language, or a programming language.

118. The system of claim 116, wherein the data entry form is created using at least one of hypertext mark up language, extensible markup language, Java, or Javascript.

119. The system of claim 112, wherein the step of interactively entering the requested data into the data entry form comprises the step of:
interactively entering the requested data into the data entry form while the data entry system is not communicatively connected.

120. The system of claim 119, further comprising the step of:
displaying the data entry form.

121. The system of claim 120, wherein the data entry form is created using at least one of a standard or proprietary document language, a script language, or a programming language.

122. The system of claim 120, wherein the data entry form is created using at least one of hypertext markup language, extensible markup language, Java, or Javascript.

123. The system of claim 119, further comprising the step of:
displaying the data entry form using a browser program.

124. The system of claim 123, wherein the data entry form is created using at least one of a standard or proprietary document language, a script language, or a programming language.

125. The system of claim 123, wherein the data entry form is created using at least one of hypertext markup language, extensible markup language, Java, or Javascript.

126. A system for implementing a process for collaborative creation of descriptions of competencies related to a position defined by a job model comprising:
a processor operable to execute computer program instructions;
a memory operable to store computer program instructions executable by the processor; and
computer program instructions stored in the memory and executable to perform the steps of:
creating a person listing including information relating to potential participants and available types of job models;
selecting a participant and a job model;
building a data entry form for entering requested data based on the selected job model;
generating an email message including the data entry form;
transmitting the email message;
receiving an email message including the requested data; and
posting the received requested data to a database.

127. The system of claim 126, wherein the data entry form provides interactive entry of data into the data entry form.

128. The system of claim 127, wherein the data entry form is created using at least one of a standard or proprietary document language, a script language, or a programming language.

129. The system of claim 127, wherein the data entry form is created using at least one of hypertext markup language, extensible markup language, Java, or Javascript.

130. The system of claim 126, wherein the data entry form provides interactive entry of data into the data entry form in a data entry system while the data entry system is not communicatively connected.

131. The system of claim 130, wherein the data entry form is created using at least one of a standard or proprietary document language, a script language, or a programming language.

132. The system of claim 131, wherein the data entry form is created using at least one of hypertext markup language, extensible markup language, Java, or Javascript.

133. The system of claim 126, wherein the step of building a data entry form comprises the step of:
building a data entry form for entering requested data defined by the dataset for the participant in the data collection process.

134. The system of claim 133, wherein the step of selecting a participant comprises the step of:
selecting a plurality of participants in the data collection process.

135. The system of claim 134, wherein the step of building a data entry form comprises the step of:
building a data entry form for entering requested data defined by the dataset for each participant in the data collection process.

136. The system of claim 135, wherein the step of generating an email message including the data entry form comprises the step of:
generating an email message including the data entry form for each participant in the data collection process.

137. The system of claim 136, wherein the step of transmitting the email message comprises the step of:
transmitting a data entry form to each participant in the data collection process.

138. The system of claim 137, wherein the step of receiving an email message including the requested data comprises the step of:
receiving an email message including the requested data for each participant in the data collection process.

139. The system of claim 138, wherein each data entry form provides interactive entry of data into the data entry form.

140. The system of claim 139, wherein each data entry form is created using at least one of a standard or proprietary document language, a script language, or a programming language.

141. The system of claim 139, wherein each data entry form is created using at least one of hypertext markup language, extensible markup language, Java, or Javascript.

142. The system of claim 138, wherein each data entry form provides interactive entry of data into the data entry form in a data entry system while the data entry system is not communicatively connected.

143. The system of claim 142, wherein each data entry form is created using at least one of a standard or proprietary document language, a script language, or a programming language.

144. The system of claim 142, wherein each data entry form is created using at least one of hypertext markup language, extensible markup language, Java, or Javascript.

145. A system for implementing a process for creation of a job candidate interview evaluation comprising:
a processor operable to execute computer program instructions;
a memory operable to store computer program instructions executable by the processor; and
computer program instructions stored in the memory and executable to perform the steps of:
creating a job model including a plurality of competencies defining qualifications and skill relating to a position in an organization;
selecting an evaluation set including a candidate for the position, a reviewer, and a date of an interview;
building a data entry form for entering requested data based on the created job model;
generating an email message including the data entry form;
transmitting the email message;
receiving an email message including the requested data; and
posting the received requested data to a database.

146. The system of claim 145, wherein the data entry form provides interactive entry of data into the data entry form.

147. The system of claim 146, wherein the data entry form is created using at least one of a standard or proprietary document language, a script language, or a programming language.

148. The system of claim 146, wherein the data entry form is created using at least one of hypertext markup language, extensible markup language, Java, or Javascript.

149. The system of claim 145, wherein the data entry form provides interactive entry of data into the data entry form in a data entry system while the data entry system is not communicatively connected.

150. The system of claim 149, wherein the data entry form is created using at least one of a standard or proprietary document language, a script language, or a programming language.

151. The system of claim 150, wherein the data entry form is created using at least one of hypertext markup language, extensible markup language, Java, or Javascript.

152. The system of claim 145, wherein the step of building a data entry form comprises the step of:
building a data entry form for entering requested data defined by the dataset for the participant in the data collection process.

153. The system of claim 152, wherein the step of selecting a participant comprises the step of:
selecting a plurality of participants in the data collection process.

154. The system of claim 153, wherein the step of building a data entry form comprises the step of:
building a data entry form for entering requested data defined by the dataset for each participant in the data collection process.

155. The system of claim 154, wherein the step of generating an email message including the data entry form comprises the step of:
generating an email message including the data entry form for each participant in the data collection process.

156. The system of claim 155, wherein the step of transmitting the email message comprises the step of:
transmitting a data entry form to each participant in the data collection process.

157. The system of claim 156, wherein the step of receiving an email message including the requested data comprises the step of:
receiving an email message including the requested data for each participant in the data collection process.

158. The system of claim 157, wherein each data entry form provides interactive entry of data into the data entry form.

159. The system of claim 158, wherein each data entry form is created using at least one of a standard or proprietary document language, a script language, or a programming language.

160. The system of claim 158, wherein each data entry form is created using at least one of hypertext markup language, extensible markup language, Java, or Javascript.

161. The system of claim 157, wherein each data entry form provides interactive entry of data into the data entry form in a data entry system while the data entry system is not communicatively connected.

162. The system of claim 161, wherein each data entry form is created using at least one of a standard or proprietary document language, a script language, or a programming language.

163. The system of claim 161, wherein each data entry form is created using at least one of hypertext markup language, extensible markup language, Java, or Javascript.

164. A system for implementing a process for creation of a performance review comprising:
a processor operable to execute computer program instructions;
a memory operable to store computer program instructions executable by the processor; and
computer program instructions stored in the memory and executable to perform the steps of:
creating a job model including a plurality of competencies defining qualifications and skill relating to a position in an organization;
selecting an evaluation set including a person to be reviewed, a reviewer, and a date of the review;
building a data entry form for entering requested data based on the created job model;
generating an email message including the data entry form;
transmitting the email message;
receiving an email message including the requested data; and
posting the received requested data to a database.

165. The system of claim 164, wherein the data entry form provides interactive entry of data into the data entry form.

166. The system of claim 165, wherein the data entry form is created using at least one of a standard or proprietary document language, a script language, or a programming language.

167. The system of claim 165, wherein the data entry form is created using at least one of hypertext markup language, extensible markup language, Java, or Javascript.

168. The system of claim 164, wherein the data entry form provides interactive entry of data into the data entry form in a data entry system while the data entry system is not communicatively connected.

169. The system of claim 168, wherein the data entry form is created using at least one of a standard or proprietary document language, a script language, or a programming language.

170. The system of claim 169, wherein the data entry form is created using at least one of hypertext markup language, extensible markup language, Java, or Javascript.

171. The system of claim 164, wherein the step of building a data entry form comprises the step of:
building a data entry form for entering requested data defined by the dataset for the participant in the data collection process.

172. The system of claim 171, wherein the step of selecting a participant comprises the step of:
selecting a plurality of participants in the data collection process.

173. The system of claim 172, wherein the step of building a data entry form comprises the step of:
building a data entry form for entering requested data defined by the dataset for each participant in the data collection process.

174. The system of claim 173, wherein the step of generating an email message including the data entry form comprises the step of:
generating an email message including the data entry form for each participant in the data collection process.

175. The system of claim 174, wherein the step of transmitting the email message comprises the step of:
transmitting a data entry form to each participant in the data collection process.

176. The system of claim 175, wherein the step of receiving an email message including the requested data comprises the step of:
receiving an email message including the requested data for each participant in the data collection process.

177. The system of claim 176, wherein each data entry form provides interactive entry of data into the data entry form.

178. The system of claim 177, wherein each data entry form is created using at least one of a standard or proprietary document language, a script language, or a programming language.

179. The system of claim 178, wherein each data entry form is created using at least one of hypertext markup language, extensible markup language, Java, or Javascript.

180. The system of claim 176, wherein each data entry form provides interactive entry of data into the data entry form in a data entry system while the data entry system is not communicatively connected.

181. The system of claim 180, wherein each data entry form is created using at least one of a standard or proprietary document language, a script language, or a programming language.

182. The system of claim 180, wherein each data entry form is created using at least one of hypertext markup language, extensible markup language, Java, or Javascript.

183. A computer program product for performing a data collection process comprising:
a computer readable medium;
computer program instructions, recorded on the computer readable medium, executable by a processor, for performing the steps of
building a data entry form for entering requested data;
generating an email message including the data entry form;
transmitting the email message;
receiving an email message including the requested data; and
posting the received requested data to a database.

184. The computer program product of claim 183, wherein the data entry form provides interactive entry of data into the data entry form.

185. The computer program product of claim 184, wherein the data entry form is created using at least one of a standard or proprietary document language, a script language, or a programming language.

186. The computer program product of claim 184, wherein the data entry form is created using at least one of hypertext markup language, extensible markup language, Java, or Javascript.

187. The computer program product of claim 183, wherein the data entry form provides interactive entry of data into the data entry form in a data entry system while the data entry system is not communicatively connected.

188. The computer program product of claim 187, wherein the data entry form is created using at least one of a standard or proprietary document language, a script language, or a programming language.

189. The computer program product of claim 188, wherein the data entry form is created using at least one of hypertext markup language, extensible markup language, Java, or Javascript.

190. The computer program product of claim 183, further comprising the steps of:
creating a dataset defining data that is to be collected; and
selecting a participant in the data collection process.

191. The computer program product of claim 190, wherein the step of building a data entry form comprises the step of:
building a data entry form for entering requested data defined by the dataset for the participant in the data collection process.

192. The computer program product of claim 190, wherein the step of selecting a participant in the data collection process comprises the step of:
selecting a plurality of participants in the data collection process.

193. The computer program product of claim 192, wherein the step of building a data entry form comprises the step of:
building a data entry form for entering requested data defined by the dataset for each participant in the data collection process.

194. The computer program product of claim 193, wherein the step of generating an email message including the data entry form comprises the step of:
generating an email message including the data entry form for each participant in the data collection process.

195. The computer program product of claim 194, wherein the step of transmitting the email message comprises the step of:
transmitting a data entry form to each participant in the data collection process.

196. The computer program product of claim 195, wherein the step of receiving an email message including the requested data comprises the step of:
receiving an email message including the requested data for each participant in the data collection process.

197. The computer program product of claim 196, wherein each data entry form provides interactive entry of data into the data entry form.

198. The computer program product of claim 197, wherein each data entry form is created using at least one of a standard or proprietary document language, a script language, or a programming language.

199. The computer program product of claim 198, wherein each data entry form is created using at least one of hypertext markup language, extensible markup language, Java, or Javascript.

200. The computer program product of claim 199, wherein each data entry form provides interactive entry of data into the data entry form in a data entry system while the data entry system is not communicatively connected.

201. The computer program product of claim 200, wherein each data entry form is created using at least one of a standard or proprietary document language, a script language, or a programming language.

202. The computer program product of claim 200, wherein each data entry form is created using at least one of hypertext markup language, extensible markup language, Java, or Javascript.

203. A computer program product for performing a data collection process in a data entry system comprising:
a computer readable medium;
computer program instructions, recorded on the computer readable medium, executable by a processor, for performing the steps of
receiving an email message including a data entry form requesting data;
extracting the data entry form from the email message;
interactively entering the requested data into the data entry form; and
transmitting an email message including the entered data.

204. The computer program product of claim 203, further comprising the step of:
displaying the data entry form.

205. The computer program product of claim 204, wherein the data entry form is created using at least one of a standard or proprietary document language, a script language, or a programming language.

206. The computer program product of claim 204, wherein the data entry form is created using at least one of hypertext markup language, extensible markup language, Java, or Javascript.

207. The computer program product of claim 203, further comprising the step of:
displaying the data entry form using a browser program.

208. The computer program product of claim 207, wherein the data entry form is created using at least one of a standard or proprietary document language, a script language, or a programming language.

209. The computer program product of claim 207, wherein the data entry form is created using at least one of hypertext markup language, extensible markup language, Java, or Javascript.

210. The computer program product of claim 203, wherein the step of interactively entering the requested data into the data entry form comprises the step of:
interactively entering the requested data into the data entry form while the data entry system is not communicatively connected.

211. The computer program product of claim 210, further comprising the step of:
displaying the data entry form.

212. The computer program product of claim 211, wherein the data entry form is created using at least one of a standard or proprietary document language, a script language, or a programming language.

213. The computer program product of claim 211, wherein the data entry form is created using at least one of hypertext markup language, extensible markup language, Java, or Javascript.

214. The computer program product of claim 210, further comprising the step of:
displaying the data entry form using a browser program.

215. The computer program product of claim 214, wherein the data entry form is created using at least one of a standard or proprietary document language, a script language, or a programming language.

216. The computer program product of claim 214, wherein the data entry form is created using at least one of hypertext markup language, extensible markup language, Java, or Javascript.

217. A computer program product for performing process for collaborative creation of descriptions of competencies related to a position defined by a job model comprising:
a computer readable medium;
computer program instructions, recorded on the computer readable medium, executable by a processor, for performing the steps of
creating a person listing including information relating to potential participants and available types of job models;
selecting a participant and a job model;
building a data entry form for entering requested data based on the selected job model;
generating an email message including the data entry form;
transmitting the email message;
receiving an email message including the requested data; and
posting the received requested data to a database.

218. The computer program product of claim 217, wherein the data entry form provides interactive entry of data into the data entry form.

219. The computer program product of claim 218, wherein the data entry form is created using at least one of a standard or proprietary document language, a script language, or a programming language.

220. The computer program product of claim 218, wherein the data entry form is created using at least one of hypertext markup language, extensible markup language, Java, or Javascript.

221. The computer program product of claim 217, wherein the data entry form provides interactive entry of data into the data entry form in a data entry system while the data entry system is not communicatively connected.

222. The computer program product of claim 221, wherein the data entry form is created using at least one of a standard or proprietary document language, a script language, or a programming language.

223. The computer program product of claim 222, wherein the data entry form is created using at least one of hypertext markup language, extensible markup language, Java, or Javascript.

224. The computer program product of claim 217, wherein the step of building a data entry form comprises the step of:
building a data entry form for entering requested data defined by the dataset for the participant in the data collection process.

225. The computer program product of claim 224, wherein the step of selecting a participant comprises the step of:
selecting a plurality of participants in the data collection process.

226. The computer program product of claim 225, wherein the step of building a data entry form comprises the step of:
building a data entry form for entering requested data defined by the dataset for each participant in the data collection process.

227. The computer program product of claim 226, wherein the step of generating an email message including the data entry form comprises the step of:
generating an email message including the data entry form for each participant in the data collection process.

228. The computer program product of claim 227, wherein the step of transmitting the email message comprises the step of:
transmitting a data entry form to each participant in the data collection process.

229. The computer program product of claim 228, wherein the step of receiving an email message including the requested data comprises the step of:
receiving an email message including the requested data for each participant in the data collection process.

230. The computer program product of claim 229, wherein each data entry form provides interactive entry of data into the data entry form.

231. The computer program product of claim 230, wherein each data entry form is created using at least one of a standard or proprietary document language, a script language, or a programming language.

232. The computer program product of claim 230, wherein each data entry form is created using at least one of hypertext markup language, extensible markup language, Java, or Javascript.

233. The computer program product of claim 229, wherein each data entry form provides interactive entry of data into the data entry form in a data entry system while the data entry system is not communicatively connected.

234. The computer program product of claim 233, wherein each data entry form is created using at least one of a standard or proprietary document language, a script language, or a programming language.

235. The computer program product of claim 233, wherein each data entry form is created using at least one of hypertext markup language, extensible markup language, Java, or Javascript.

236. A computer program product for performing a process for creation of a job candidate interview evaluation comprising:
a computer readable medium;
computer program instructions, recorded on the computer readable medium, executable by a processor, for performing the steps of
creating a job model including a plurality of competencies defining qualifications and skill relating to a position in an organization;
selecting an evaluation set including a candidate for the position, a reviewer, and a date of an interview;
building a data entry form for entering requested data based on the created job model;
generating an email message including the data entry form;
transmitting the email message;
receiving an email message including the requested data; and
posting the received requested data to a database.

237. The computer program product of claim 236, wherein the data entry form provides interactive entry of data into the data entry form.

238. The computer program product of claim 237, wherein the data entry form is created using at least one of a standard or proprietary document language, a script language, or a programming language.

239. The computer program product of claim 237, wherein the data entry form is created using at least one of hypertext markup language, extensible markup language, Java, or Javascript.

240. The computer program product of claim 236, wherein the data entry form provides interactive entry of data into the data entry form in a data entry system while the data entry system is not communicatively connected.

241. The computer program product of claim 240, wherein the data entry form is created using at least one of a standard or proprietary document language, a script language, or a programming language.

242. The computer program product of claim 241, wherein the data entry form is created using at least one of hypertext markup language, extensible markup language, Java, or Javascript.

243. The computer program product of claim 236, wherein the step of building a data entry form comprises the step of:
building a data entry form for entering requested data defined by the dataset for the participant in the data collection process.

244. The computer program product of claim 243, wherein the step of selecting a participant comprises the step of:
selecting a plurality of participants in the data collection process.

245. The computer program product of claim 244, wherein the step of building a data entry form comprises the step of:
building a data entry form for entering requested data defined by the dataset for each participant in the data collection process.

246. The computer program product of claim 245, wherein the step of generating an email message including the data entry form comprises the step of:
generating an email message including the data entry form for each participant in the data collection process.

247. The computer program product of claim 246, wherein the step of:
transmitting the email message comprises the step of transmitting a data entry form to each participant in the data collection process.

248. The computer program product of claim 247, wherein the step of receiving an email message including the requested data comprises the step of:
receiving an email message including the requested data for each participant in the data collection process.

249. The computer program product of claim 248, wherein each data entry form provides interactive entry of data into the data entry form.

250. The computer program product of claim 249, wherein each data entry form is created using at least one of a standard or proprietary document language, a script language, or a programming language.

251. The computer program product of claim 249, wherein each data entry form is created using at least one of hypertext markup language, extensible markup language, Java, or Javascript.

252. The computer program product of claim 248, wherein each data entry form provides interactive entry of data into the data entry form in a data entry system while the data entry system is not communicatively connected.

253. The computer program product of claim 252, wherein each data entry form is created using at least one of a standard or proprietary document language, a script language, or a programming language.

254. The computer program product of claim 252, wherein each data entry form is created using at least one of hypertext markup language, extensible markup language, Java, or Javascript.

255. A computer program product for performing a process for creation of a performance review comprising:
a computer readable medium;
computer program instructions, recorded on the computer readable medium, executable by a processor, for performing the steps of
creating a job model including a plurality of competencies defining qualifications and skill relating to a position in an organization;
selecting an evaluation set including a person to be reviewed, a reviewer, and a date of the review;
building a data entry form for entering requested data based on the created job model;
generating an email message including the data entry form;
transmitting the email message;
receiving an email message including the requested data; and
posting the received requested data to a database.

256. The computer program product of claim 255, wherein the data entry form provides interactive entry of data into the data entry form.

257. The computer program product of claim 256, wherein the data entry form is created using at least one of a standard or proprietary document language, a script language, or a programming language.

258. The computer program product of claim 256, wherein the data entry form is created using at least one of hypertext markup language, extensible markup language, Java, or Javascript.

259. The computer program product of claim 255, wherein the data entry form provides interactive entry of data into the data entry form in a data entry system while the data entry system is not communicatively connected.

260. The computer program product of claim 259, wherein the data entry form is created using at least one of a standard or proprietary document language, a script language, or a programming language.

261. The computer program product of claim 260, wherein the data entry form is created using at least one of hypertext markup language, extensible markup language, Java, or Javascript.

262. The computer program product of claim 255, wherein the step of building a data entry form comprises the step of:
building a data entry form for entering requested data defined by the dataset for the participant in the data collection process.

263. The computer program product of claim 262, wherein the step of selecting a participant comprises the step of:
selecting a plurality of participants in the data collection process.

264. The computer program product of claim 262, wherein the step of building a data entry form comprises the step of:
building a data entry form for entering requested data defined by the dataset for each participant in the data collection process.

265. The computer program product of claim 264, wherein the step of generating an email message including the data entry form comprises the step of:
generating an email message including the data entry form for each participant in the data collection process.

266. The computer program product of claim 265, wherein the step of transmitting the email message comprises the step of:
transmitting a data entry form to each participant in the data collection process.

267. The computer program product of claim 266, wherein the step of receiving an email message including the requested data comprises the step of:
receiving an email message including the requested data for each participant in the data collection process.

268. The computer program product of claim 267, wherein each data entry form provides interactive entry of data into the data entry form.

269. The computer program product of claim 268, wherein each data entry form is created using at least one of a standard or proprietary document language, a script language, or a programming language.

270. The computer program product of claim 269, wherein each data entry form is created using at least one of hypertext markup language, extensible markup language, Java, or Javascript.

271. The computer program product of claim 267, wherein each data entry form provides interactive entry of data into the data entry form in a data entry system while the data entry system is not communicatively connected.

272. The computer program product of claim 271, wherein each data entry form is created using at least one of a standard or proprietary document language, a script language, or a programming language.

273. The computer program product of claim 271, wherein each data entry form is created using at least one of hypertext markup language, extensible markup language, Java, or Javascript.
